(19) United States
(12) Patent Application Publication
(10) Pub. No.: US 2015/0228236 A1
(43) Pub. Date: Aug. 13, 2015

(54) DISPLAY DEVICE

(71) Applicant: Sharp Kabushiki Kaisha, Osaka (JP)

(72) Inventor: Yoshinori Yamamoto, Osaka (JP)

(73) Assignee: Sharp Kabushiki Kaisha, Osaka (JP)

(21) Appl. No.: 14/417,943

(22) PCT Filed: Jul. 25, 2013
(86) PCT No.: PCT/JP2013/070206

§ 371 Date: Jan. 28, 2015

(30) Foreign Application Priority Data
Jul. 31, 2012 (JP) 2012-169903

(51) Int. Cl. G09G 3/36

(52) U.S. Cl. CPC G09G 3/3622; G09G 2320/0219; G09G 2310/0281

(57) ABSTRACT

A liquid crystal display device as a display device is provided with the following: a driver circuit chip that outputs a driving signal for controlling the display on a liquid crystal display unit; and wiring for supplying the driving signal to the liquid crystal display unit. The driver circuit chip and the wiring are formed directly on a substrate of the liquid crystal display unit and, on the substrate, are simultaneously covered by a single insulating member.

### TECHNICAL FIELD

The present invention relates to a display device to which a driver circuit chip has been mounted using a COG method.

### BACKGROUND ART

Patent Document 1 discloses a description of a conventional configuration for preventing static electricity from destroying a driver circuit of a liquid crystal display device. The liquid crystal display device described in Patent Document 1 has a configuration in which an electrode terminal, which is formed on a substrate that forms a portion of a liquid crystal display panel, is connected to a connecting terminal, which is formed on a flexible substrate on which a driver circuit chip has been mounted. The driver circuit chip and a terminal part that is exposed to the exterior, which does not include the connecting part of the above-mentioned electrode terminal or the above-mentioned connecting terminal, are both covered by a covering tape having insulating properties. The discharge of static electricity at the exposed part of the terminal can be prevented with this configuration, which could otherwise be discharged by a finger of a human, the operating machine, and the like directly touching the exposed part. The configuration can also prevent static electricity from destroying the internal circuit of the driver circuit chip.

The liquid crystal display device described in the above-mentioned Patent Document 1 has a driver circuit chip that is mounted by a so-called COF (chip-on-film) method. However, in recent years, liquid crystal display devices to which driver circuit chips are mounted using a COG (chip-on-glass) method have also been proposed. FIG. 15A is a perspective view of the primary parts of a conventional liquid crystal display device 100 on which a driver circuit chip has been mounted using the COG method. FIG. 15B is a cross-sectional view taken along the line A-A′ in FIG. 15A. FIG. 15C is a cross-sectional view taken along the line B-B′ in FIG. 15A. As a matter of convenience, a shield case 118 that will be mentioned later is omitted in FIG. 15A.

The liquid crystal display device 100 has a liquid crystal panel 101 and a backlight (not shown). The liquid crystal panel 101 has a pair of substrates 111 and 112 that sandwich a liquid crystal layer (not shown). Pixel electrodes that correspond to each pixel of the liquid crystal display panel 101, TFTs (thin-film transistors) as switching elements for turning on and off the display of each pixel, and wiring that connects to each switching element are formed on one substrate 111 in an area that faces the other substrate 112. A color filter for displaying color and a counter electrode that faces the pixel electrodes through the liquid crystal layer are formed on the other substrate 112.

Additionally, a driver circuit chip 113 that outputs a drive signal for controlling the display of each pixel is directly mounted using the COG method on one substrate 111 outside the area that faces the other substrate 112. Wiring 114 for supplying the above-mentioned drive signal to each pixel (switching element) is also formed thereon. The above-mentioned driver circuit chip 113 is electrically connected to an FPC (flexible printed circuit) 115 that is connected to a control device. Polarizing plates 116 and 117 that only transmit a prescribed linear polarization are respectively disposed on either side of the substrates 111 and 112 that surround the liquid crystal layer.

The substrates 111 and 112, along with the backlight, are housed in a shield case 118. An opening 118a is formed in the shield case 118 and the polarizing plate 117 (that is positioned on the light emitting side) is located further inside than the opening 118a.

Light that is emitted from the backlight and modulated in the liquid crystal layer according to image signals is passed through to the outside via the polarizing plate 117. This allows an observer to visually recognize images displayed on the liquid crystal display device 100.

### RELATED ART DOCUMENT

### Patent Document

Patent Document 1: Japanese Patent Application Laid-Open Publication No. H6-95137 (See claim 1, paragraph [0016], FIG. 1, etc.)

### SUMMARY OF THE INVENTION

### Problems to be Solved by the Invention

The surface potential of the driver circuit chip 113 mounted on the substrate 111 is a gate-off potential (VGL). Meanwhile, the surface potential of the inner surface of the shield case 118, placed directly above the driver circuit chip 113, is usually a ground-potential (GND). Therefore, it is necessary to prevent display abnormalities caused by a short circuit between the driver circuit chip 113 and the shield case 118 placed directly above thereof. Additionally, on the substrate 111 on which the TFTs are disposed, there are parts of the wiring 114 that could corrode due to adhered oil and grease. In order to prevent corrosion and scratches of the wiring, it is necessary to protect the surface of the wiring using an insulating member 121 (see FIG. 15C).

Methods of preventing display abnormalities due to the above-mentioned short circuit include: providing clearance between the driver circuit chip 113 and the inner surface of the shield case 118 that is directly above thereof; or applying or attaching an insulating member 122 on the driver circuit chip 113 or to the inner surface of the shied case 118 (see FIG. 15B). However, the former method of providing clearance is not desirable in terms of thinning a module, since doing so would increase the thickness of the module. Additionally, the method of providing the insulating member 122 on the driver circuit chip 113 requires preparing two types of insulating members: the insulating member 122 for preventing a short circuit, and the insulating member 121 for protecting the surface of the wiring, and requires applying and attaching both separately, which increases manufacturing costs.

The present invention was developed to solve the above-mentioned problems. The aim of the present invention is to provide a display device that, in a configuration having a driver circuit chip mounted with a COG method, can simultaneously protect wiring and prevent display abnormalities due to a short circuit without increasing the thickness or cost thereof.

### Means for Solving the Problems

A display device according to one aspect of the present invention includes: a driver circuit chip that outputs a driving signal for controlling display of a display unit; and wiring that supplies the driving signal to the display unit; wherein the driver circuit chip and the wiring are directly formed on a substrate of the display unit and, on the substrate, are simultaneously covered by a single insulating member.

### Effects of the Invention

According to the above-mentioned configuration, in a configuration equipped with a driver circuit chip that is mounted using the COG method, it is possible to simultaneously protect wiring and prevent display abnormalities due to a short circuit without increasing thickness or cost.

### BRIEF DESCRIPTION OF THE DRAWINGS

FIG. 1 is a schematic perspective view, as well as an enlarged view of a selected portion, showing a configuration of a liquid crystal display device according to an embodiment of the present invention.

FIG. 2 is a perspective view that shows the exterior of the above-mentioned liquid crystal display device.

FIG. 3A is a cross-sectional view taken along the line A-A′ in FIG. 1.

FIG. 3B is a cross-sectional view taken along the line B-B′ in FIG. 1.

FIG. 4A is a perspective view of an insulating member that can be attached to a substrate of the above-mentioned liquid crystal display device.

FIG. 4B is a plan view of the above-mentioned insulating member.

FIG. 5 is a perspective view of the above-mentioned liquid crystal display device before attaching the above-mentioned insulating member.

FIG. 6 is a perspective view that shows the attaching of the above-mentioned insulating member to the substrate.

FIG. 7A is a perspective view of an insulating member according to another embodiment of the present invention.

FIG. 7B is a plan view of the above-mentioned insulating member.

FIG. 8 is a perspective view that shows the attaching of the above-mentioned insulating member to the substrate.

FIG. 9 is a plan view of an insulating member according to another embodiment of the present invention.

FIG. 10 is a perspective view that shows the attaching of the above-mentioned insulating member to the substrate.

FIG. 11A is a plan view that shows another configuration of the above-mentioned insulating member.

FIG. 11B is a plan view that shows another configuration of the above-mentioned insulating member.

FIG. 12 is a plan view of an insulating member according to another embodiment of the present invention.

FIG. 13 is a perspective view that shows the attaching of the above-mentioned insulating member to a substrate.

FIG. 14 is a plan view that shows another configuration of the above-mentioned insulating member.

FIG. 15A is a perspective view of the primary parts of a conventional liquid crystal display device.

FIG. 15B is a cross-sectional view taken along the line A-A′ in FIG. 15A.

FIG. 15C is a cross-sectional view taken along the line B-B′ in FIG. 15A.

### DETAILED DESCRIPTION OF EMBODIMENTS

### Embodiment 1

An embodiment of the present invention will be explained below with reference to figures. For convenience, repeated descriptions will be omitted by annotating each part with the same number in each embodiment in which the same configurations are shown.

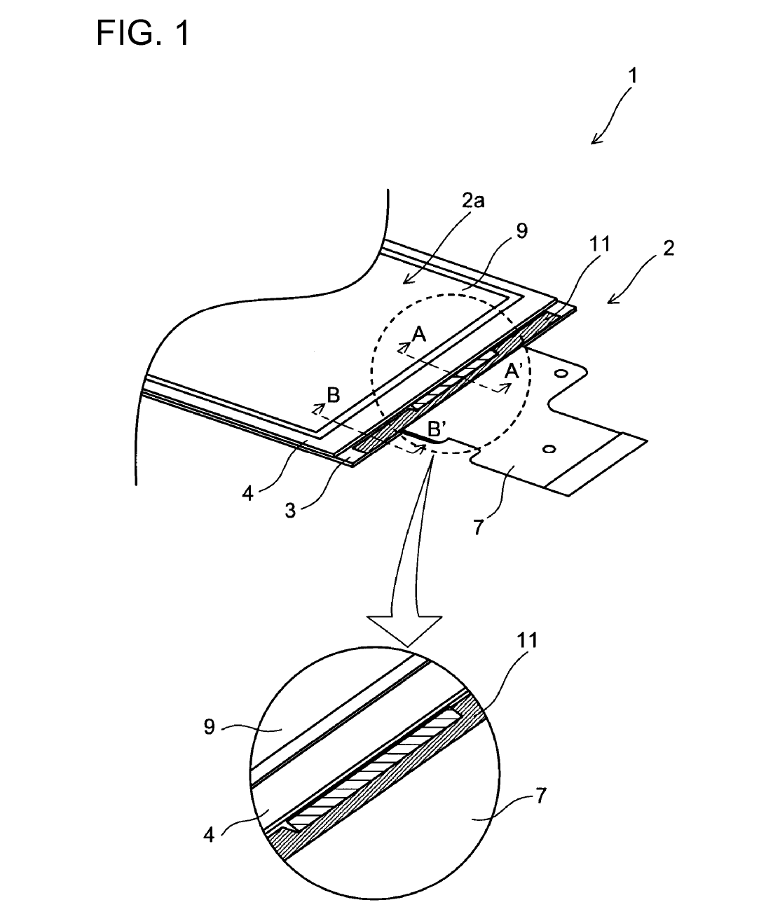

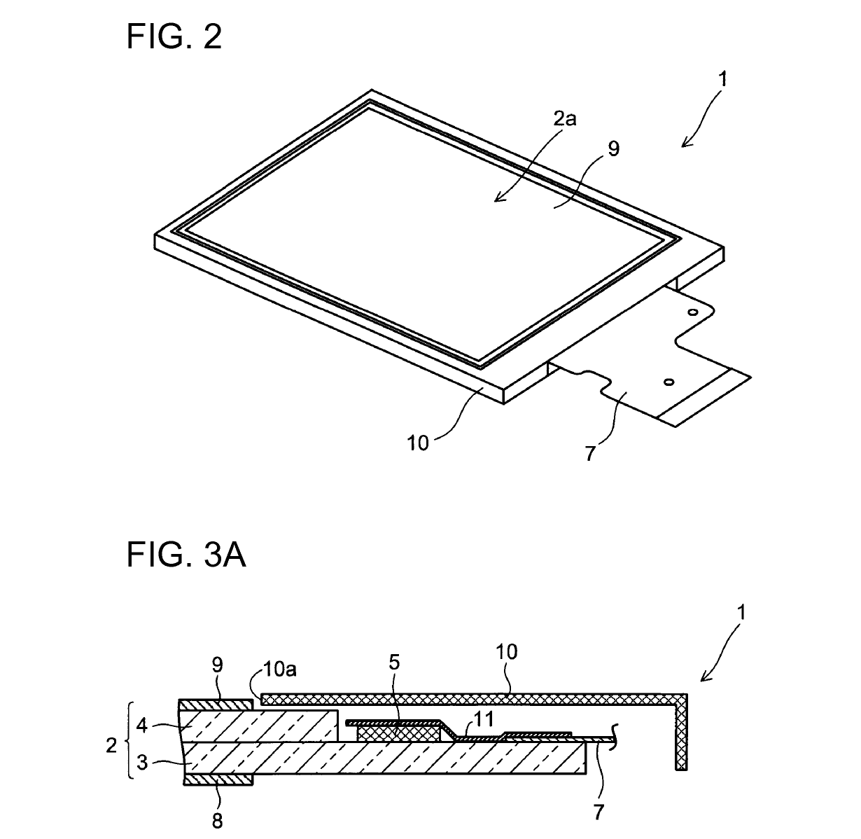

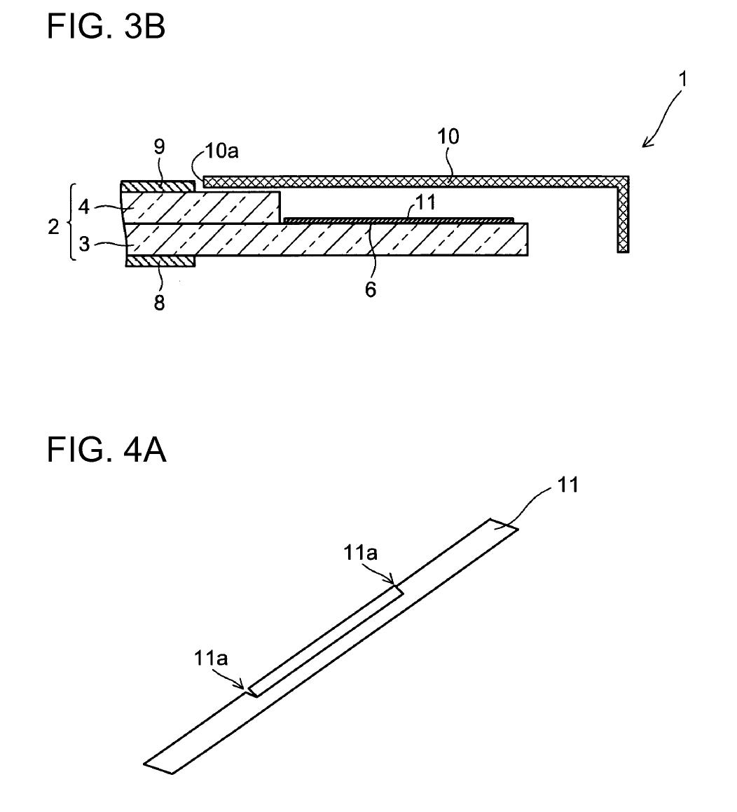

FIG. 1 is a schematic perspective view, as well as an enlarged view of a selected portion, showing a configuration of a liquid crystal display device 1 (display device) in the present embodiment. FIG. 2 is a perspective view that shows the exterior of the liquid crystal display device 1. FIG. 3A is a cross-sectional view taken along the line A-A′ in FIG. 1 and FIG. 3B is a cross-sectional view taken along the line B-B′ in FIG. 1. For convenience, in FIG. 1, an insulating member 11 that will later be described is shown with crosshatches and a shield case 10 is not shown.

The liquid crystal display device 1 has a liquid crystal panel 2 and a backlight (not shown) for illuminating the liquid crystal panel 2. The liquid crystal panel 2 has a liquid crystal display unit 2a (display unit) that displays images using a liquid crystal layer (not shown) sandwiched between a pair of substrates 3 and 4. In the liquid crystal panel 2, the liquid crystal display unit 2a has a plurality of pixels and corresponds to an area sandwiched between polarizing plates 8 and 9 that will be described later. The above-mentioned liquid crystal layer is sealed between the pair of substrates 3 and 4 by a sealing material (not shown).

The pair of substrates 3 and 4 are made of glass. The area of one substrate 3 facing the other substrate 4 has pixel electrodes that correspond to each pixel of the liquid crystal display unit 2a, TFTs as switching elements for turning on and off the display of each pixel in accordance with a drive signal that will be described, and wiring (gate wiring and source wiring) that connects to each switching element. Color filters for displaying colors and a counter electrode that faces the pixel electrodes through the liquid crystal layer are formed on the other substrate 4.

Additionally, a driver circuit chip 5, which is a driver IC, outputs a drive signal for controlling the display of each pixel of the liquid crystal display unit 2a and is directly mounted using the COG method on one substrate 3 outside the area that faces the other substrate 4. Wiring 6 for supplying the above-mentioned drive signal to the liquid crystal display unit 2a (e.g., TFTs) is also formed thereon. Furthermore, the wiring 6 includes the above-mentioned gate wiring and source wiring. The driver circuit chip 5 is electrically connected to an FPC 7 and the FPC 7 is connected to a control device (not shown) that controls the driving of the driver circuit chip 5. When viewed in a plan view, the driver circuit chip 5 is rectangular in shape and the long side is positioned on the substrate 3 along the short side of the rectangular display screen of the liquid crystal panel 2.

Alignment films (not shown) for orienting liquid crystal molecules in a prescribed direction are respectively formed on the surface that faces the liquid crystal layer on each substrate 3 and 4. The polarizing plates 8 and 9 that allow only a prescribed linear polarization to pass therethrough are respectively disposed on either side of the substrates 3 and 4 opposite to the liquid crystal layer.

The above-mentioned substrates 3 and 4, along with the backlight, are housed and held in a shield case 10. An opening 10a is formed in the shield case 10 and the polarizing plate 9 that is positioned on the light emitting side is located further inside than the opening 10a.

Light that is emitted from the backlight and modulated in the liquid crystal layer in accordance with image signals is passed through to the outside via the polarizing plate 9 that is located further inside than the opening 10a. This allows an observer to visually recognize images displayed on the liquid crystal display device 1.

According to the present embodiment, the above-mentioned driver circuit chip 5 and the wiring 6 are simultaneously covered on the substrate by a single insulating member 11. The insulating member 11 is made of insulating tape (double-sided tape is also allowed) made from a resin such as PET (polyethylene terephthalate).

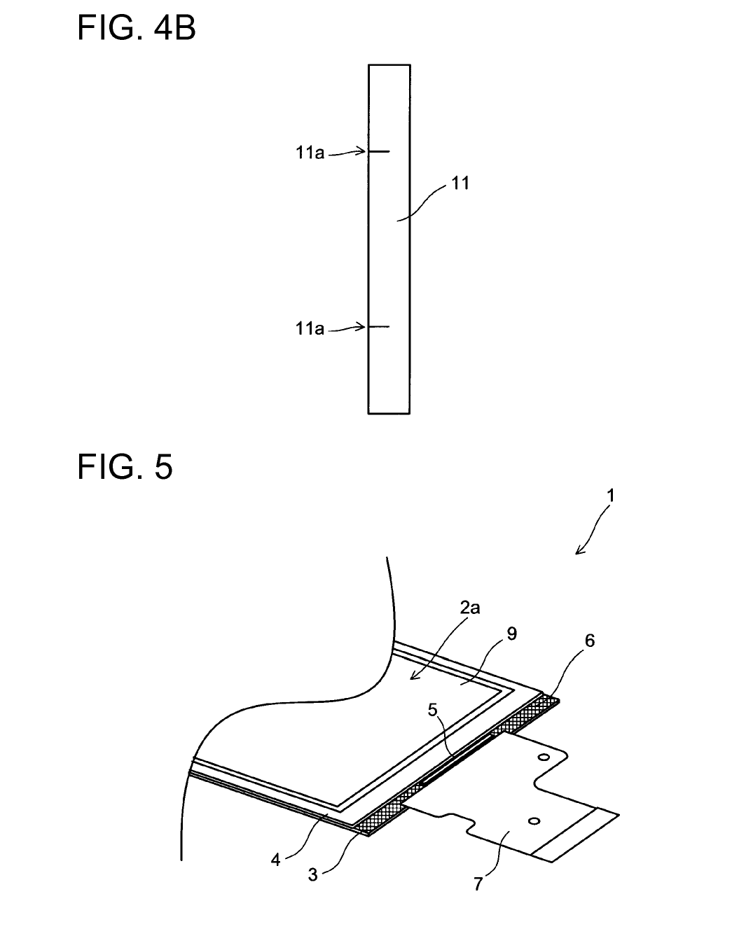

FIG. 4A is a perspective view of the insulating member 11 and FIG. 4B is a plan view of the insulating member 11. When viewed in a plan view, the insulating member 11 is rectangular in shape. Slits 11a that are linearly cut are formed in the insulating member 11 at positions that correspond to the outline of the driver circuit chip 5. According to the present embodiment, the slits 11a are formed in the insulating member 11 at two points that correspond to each short side 5a of the driver circuit chip 5. In FIG. 4A, the slits 11a are shown in a direction that is parallel to each short side 5a, but the slits 11a may also be formed at angles within a range of ±45° (−45° to +45°) to each short side 5a. One end of each slit 11a extends to the same side of the outline of the insulating member 11 (for example, the same long side) and the area between the slits 11a can be bent.

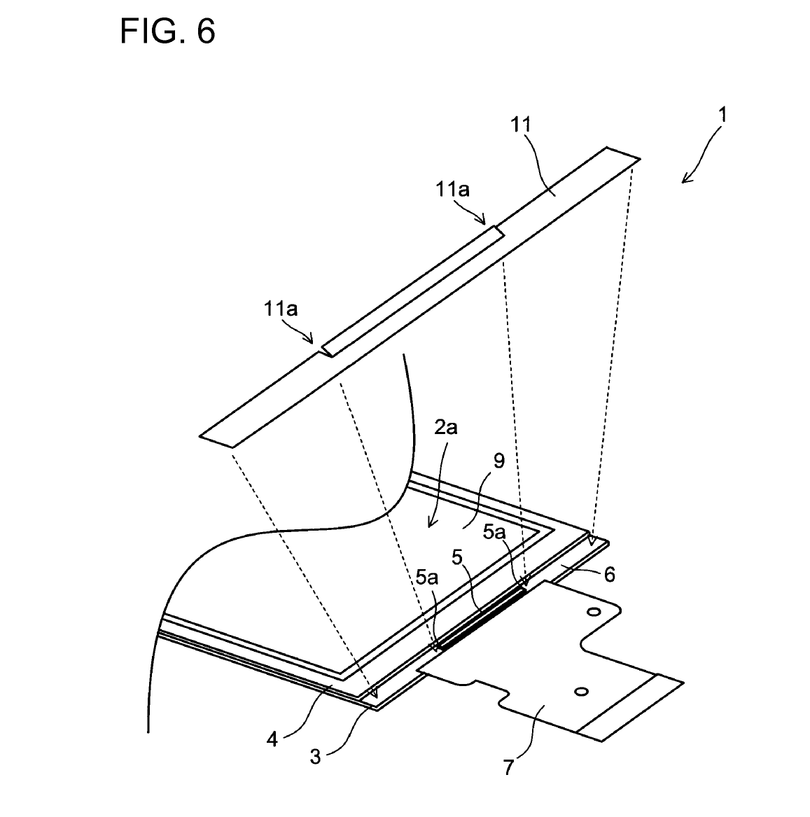

FIG. 5 is a perspective view of the liquid crystal display device 1 before attaching the insulating member 11. As shown in the same figure, in order to clarify the area in which the wiring 6 will be formed on the substrate 3, the above-mentioned area is marked with crosshatches as a matter of convenience. FIG. 6 is a perspective view that shows the attaching of the insulating member 11 to the substrate 3. As shown in FIG. 6, by attaching the insulating member 11 to the substrate 3 so that each slit 11a overlaps with each short side 5a of the driver circuit chip 5, the driver circuit chip 5 and the wiring 6 on the substrate 3 are simultaneously covered by the insulating member 11. FIG. 1 shows the driver circuit chip 5 and the wiring 6 after being simultaneously covered.

In a configuration in which the driver circuit chip 5 is directly formed on the substrate 3 using the COG method, a section of the inner surface of the shield case 10 faces the driver circuit chip 5 through the insulating member 11 as shown in FIG. 3A. The driver circuit chip 5 and the wiring 6 on the substrate 3 are simultaneously covered by a single insulating member 11, which simultaneously prevents the generation of a short circuit between the driver circuit chip 5 and the inner surface of the shield case 10 and the corrosion or scratches of the wiring 6. Therefore, it is not necessary to secure extra clearance between the driver circuit chip 5 and the inner surface of the shield case 10 to prevent a short circuit, and a short circuit can be prevented without increasing the thickness of the module.

Additionally, in comparison to a configuration in which the driver circuit chip 5 and the wiring 6 are covered by separate insulating members, fewer insulating members are used and only one attachment is required since the driver circuit chip 5 and the wiring 6 are simultaneously covered by a single insulating member 11. This decreases manufacturing costs.

Thus, according to the configuration of the present embodiment, it is possible to simultaneously protect the wiring and prevent display abnormalities due to a short circuit without increasing the thickness or cost of the module. Specifically, these effects can be achieved in a configuration in which the driver circuit chip 5 is formed using the COG method on the substrate 3 that is a glass substrate on which TFTs are disposed.

Since slits 11a are formed in the insulating member 11 at positions that correspond to the outline of the driver circuit chip 5, it is possible to create a step in the insulating member 11 that conforms to the thickness of the driver circuit chip 5. In other words, in the insulating member 11 at the position of the outline of the driver circuit chip 5, an abrupt step can be created that corresponds to the thickness of the driver circuit chip 5. Due to this, the driver circuit chip 5 and the wiring 6 can be securely protected by increasing the contact area between the insulating member 11 and both the driver circuit chip 5 and the wiring 6 as much as possible (by covering the wiring 6 with the insulating member 11 up to the position closest to the outline of the driver circuit chip 5). It is also possible to conform to various thicknesses of the driver circuit chip 5 with a single insulating member 11.

Additionally, the slits 11a can be used as guides when attaching the insulating member 11. Since the insulating member 11 can be attached by aligning the insulating member 11 and the driver circuit chip 5 using the slits 11a, not only does attaching the insulating member 11 become easier, but misalignment of the insulating member 11 with respect to the driver circuit chip 5 can be minimized.

In the insulating member 11, slits 11a are formed corresponding to each short side 5a of the driver circuit chip 5 at angles within a range of ±45° to each short side 5a. A step that corresponds to the thickness of the driver circuit chip 5 can be created in the insulating member 11 at the position of each short side 5a of the driver circuit chip 5. Thus, it is possible to protect the driver circuit chip 5 and the wiring 6 by adhering the insulating member 11 tightly to the wiring 6 that is adjacent to the short sides 5a of the driver circuit chip 5.

One end of each slit 11a extends to the same side of the outline of the insulating member 11. Because of this, a section between the slits 11a and 11a of the insulating member 11 can be bent to a position that is almost flat. Using this section, the insulating member 11 can be attached so as to cover the driver circuit chip 5, making the insulating member 11 easier to attach.

### Embodiment 2

Another embodiment of the present invention will be explained below with reference to figures.

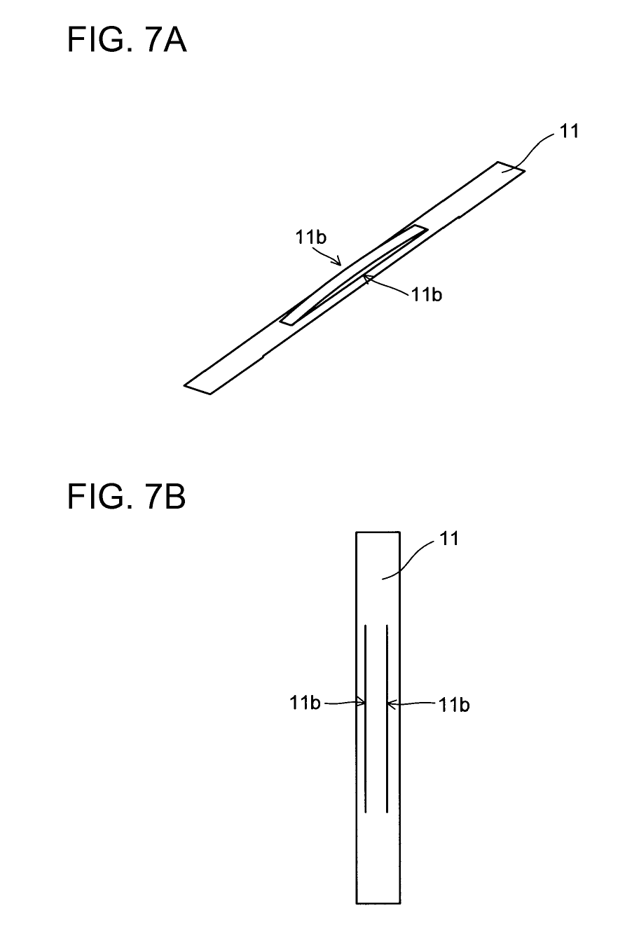

FIG. 7A is a perspective view of the insulating member 11 in the present embodiment and FIG. 7B is a plan view of the abovementioned insulating member 11. According to the present embodiment, linearly cut slits 11b are formed in the insulating member 11 (that is rectangular in shape when viewed in a plan view) at positions that correspond to the outline of the driver circuit chip 5. The slits 11b in the insulating member 11 are formed at two points that correspond to each long side 5b of the driver circuit chip 5. In FIGS. 7A and 7B, the slits 11b are shown in a direction that is parallel to each long side 5b, but the slits 11b may also be at angles within a range of ±45° to each long side 5b.

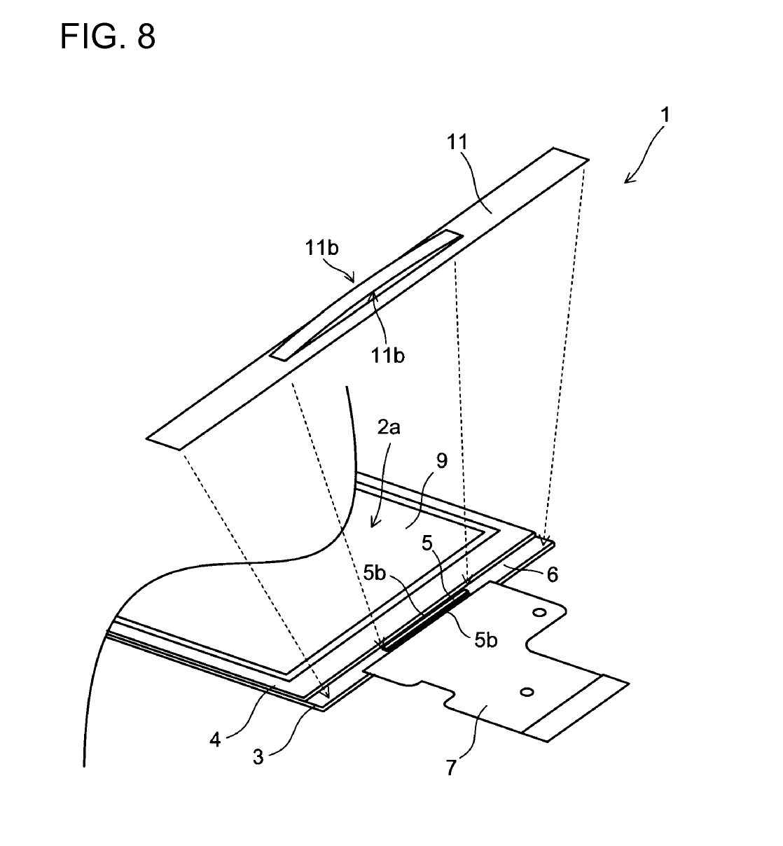

FIG. 8 is a perspective view that shows the attaching of the insulating member 11 to the substrate 3. As shown in the same figure, by attaching the insulating member 11 to the substrate 3 so that each slit 11b overlaps with each long side 5b of the driver circuit chip 5, the driver circuit chip 5 and the wiring 6 on the substrate 3 are simultaneously covered by the insulating member 11.

In the insulating member 11, slits 11b are formed corresponding to each long side 5b of the driver circuit chip 5 at angles within a range of ±45° to each long side 5b. A step that corresponds to the thickness of the driver circuit chip 5 can be created in the insulating member 11 at the position of each long side 5b of the driver circuit chip 5. Thus, it is possible to protect the driver circuit chip 5 and the wiring 6 by adhering the insulating member 11 tightly to the wiring 6 that is adjacent to the long sides 5b of the driver circuit chip 5.

According to the present embodiment, the ends of each slit 11b that are long in the direction of the long sides 5b of the driver circuit chip 5 remain inside the outline of the insulating member 11 and do not extend to the outline of the insulating member 11 (see FIG. 7 and FIG. 8). Due to this, when attaching the insulating member 11, a section between the slits 11b and 11b does not bend up in the direction of the long side 5b and stick to another section, and the driver circuit chip 5 can be securely protected by the insulating member 11.

### Embodiment 3

Another embodiment of the present invention will be explained below with reference to figures.

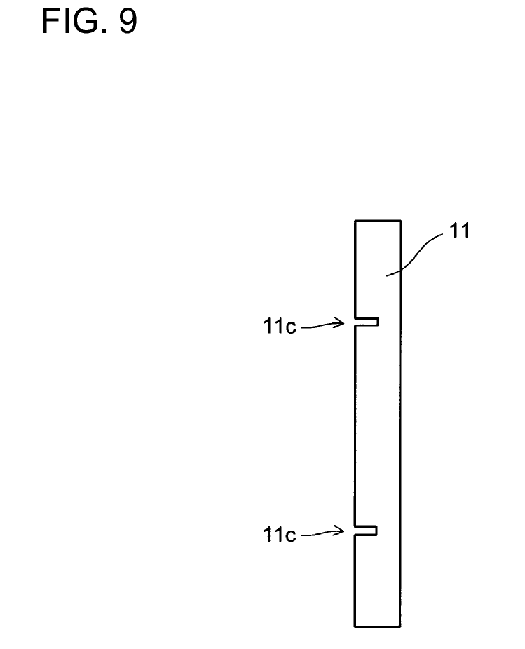

FIG. 9 is a plan view of the insulating member 11 in the present embodiment. In the present embodiment, at positions that correspond to the outline of the driver circuit chip 5, cutouts 11c that are cutout portions of the insulating member 11 are formed in the insulating member 11, which is rectangular in shape when viewed in a plan view. The cutouts 11c are formed at two positions of the insulating member 11 corresponding to each short side 5a of the driver circuit chip 5. Each cutout 11c is formed in a direction that is parallel to each short side 5a and one end extends to the same side (for example, the same long side) of the outline of the insulating member 11, creating an opening.

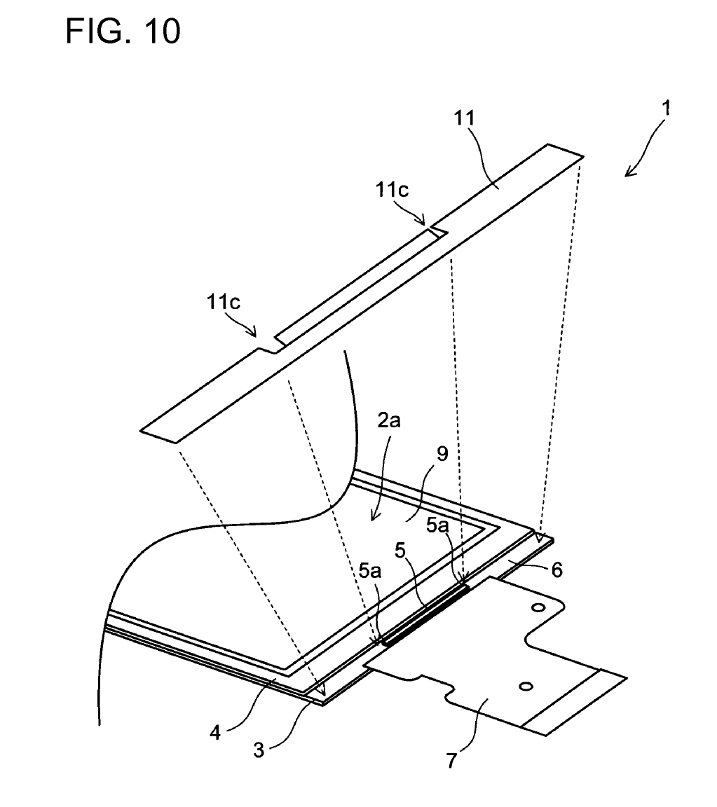

FIG. 10 is a perspective view that shows the attaching of the insulating member 11 to the substrate 3. As shown in the same figure, by attaching the insulating member 11 to the substrate 3 so that each cutout 11c overlaps with each short side 5a of the driver circuit chip 5, the driver circuit chip 5 and the wiring 6 on the substrate 3 are simultaneously covered by the insulating member 11.

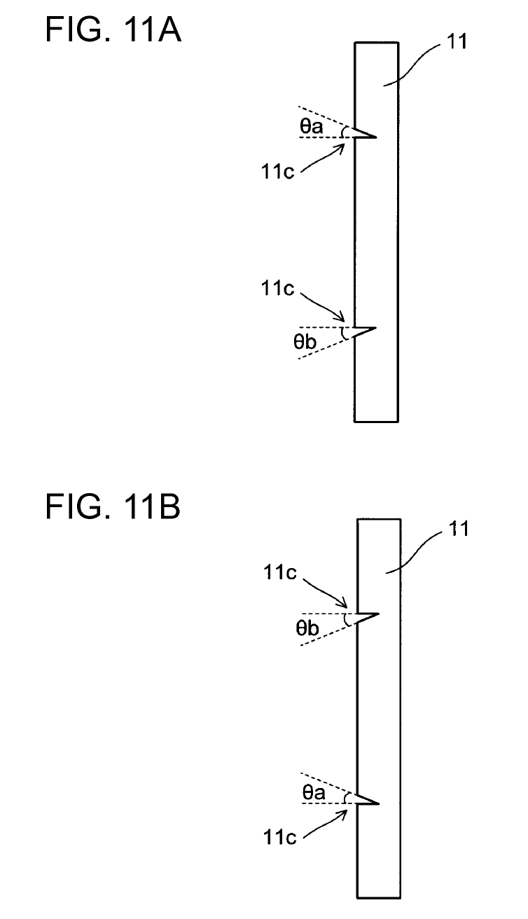

FIGS. 11A and 11B are plan views that show another configuration of the insulating member 11 in the present embodiment. Each cutout 11c may be formed by cutting out a portion of the insulating member 11 at an angle within a range of ±45° to each short side 5a of the driver circuit chip 5. In other words, each cutout 11c may be formed by cutting out a portion of the insulating member 11 at an angle θa that is 0° to 45° with respect to the short side 5a, or at an angle θb that is −45° or above and below 0° with respect to the short side 5a. The cutouts 11c may be formed by a combination of a cutout formed at angle θa and a cutout formed at angle θb (see FIGS. 11A and 11B), or by cutouts both formed at angle θa, or by cutouts both formed at angle θb.

Even in configurations such as the present embodiment, in which the cutouts 11c are formed in the insulating member 11, it is possible to create a step in the insulating member 11 that conforms to the thickness of the driver circuit chip 5 at the position of the outline of the driver circuit chip 5. Due to this, the driver circuit chip 5 and the wiring 6 can be properly protected by increasing the contact area between the insulating member 11 and both the driver circuit chip 5 and the wiring 6.

By forming each cutout 11c that corresponds to each short side 5a of the driver circuit chip 5 within the range of the above-mentioned angles, a step that corresponds to the thickness of the driver circuit chip 5 can be created in the insulating member 11 at the position of each short side 5a of the driver circuit chip 5. Thus, it is possible to protect the driver circuit chip 5 and the wiring 6 by adhering the insulating member 11 tightly to the wiring 6 that is adjacent to the short sides 5a of the driver circuit chip 5.

Additionally, one end of each cutout 11c extends to the same side of the outline of the insulating member 11, creating an opening. Because of this, a section between the cutouts 11c and 11c of the insulating member 11 can be bent to a position that is almost flat. Using this section, the insulating member 11 can be attached so as to cover the driver circuit chip 5, making the insulating member 11 easier to attach.

### Embodiment 4

Another embodiment of the present invention will be explained below with reference to figures.

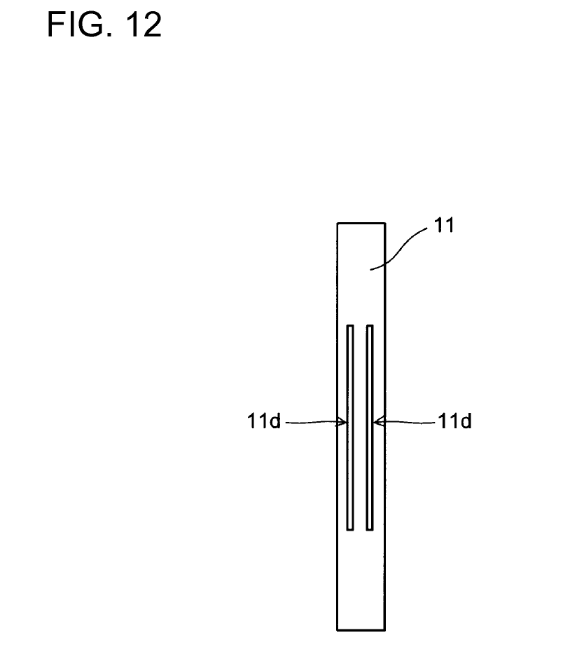

FIG. 12 is a plan view of the insulating member 11 in the present embodiment. In the present embodiment, cutouts 11d that are cutout portions of the insulating member 11 are formed in the insulating member 11 (that is rectangular in shape when viewed in a plan view) at positions that correspond to the outline of the driver circuit chip 5. The cutouts 11d are formed in the insulating member 11 at two positions corresponding to each long side 5b of a driver circuit chip 5. In FIG. 12, the cutouts 11d are shown in a direction that is parallel to each long side 5b, but the cutouts 11d may also be formed at angles within a range of ±45° to each long side 5b.

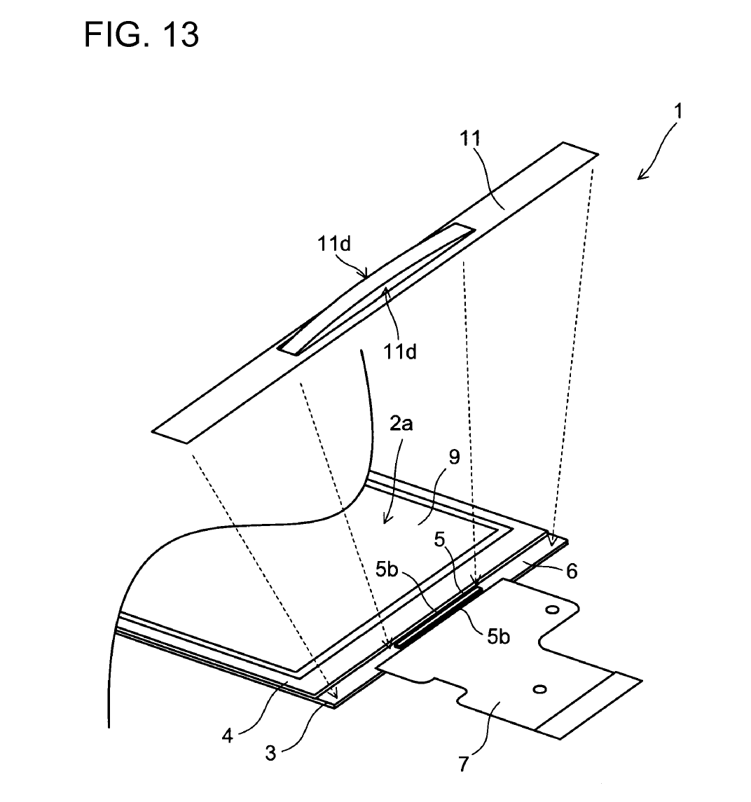

FIG. 13 is a perspective view that shows the attaching of the insulating member 11 to the substrate 3. As shown in the same figure, by attaching the insulating member 11 to the substrate 3 so that each cutout 11d overlaps with each long side 5b of the driver circuit chip 5, the driver circuit chip 5 and the wiring 6 on the substrate 3 are simultaneously covered by the insulating member 11.

In the insulating member 11, the cutouts 11d are formed corresponding to each long side 5b of the driver circuit chip 5 and are formed by cutting out a portion of the insulating member 11 at angles within a range of ±45° to each long side 5b. A step that corresponds to the thickness of the driver circuit chip 5 can also be created in the insulating member 11 at the position of each long side 5b of the driver circuit chip 5. Thus, it is possible to protect the driver circuit chip 5 and the wiring 6 by adhering the insulating member 11 tightly to the wiring 6 that is adjacent to the long sides 5b of the driver circuit chip 5.

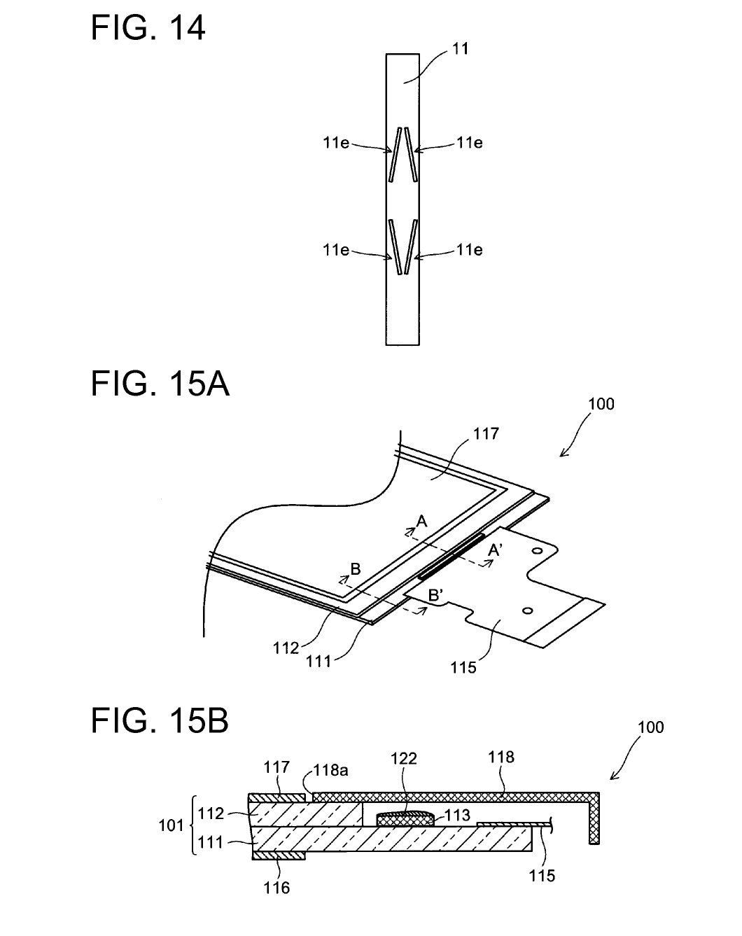

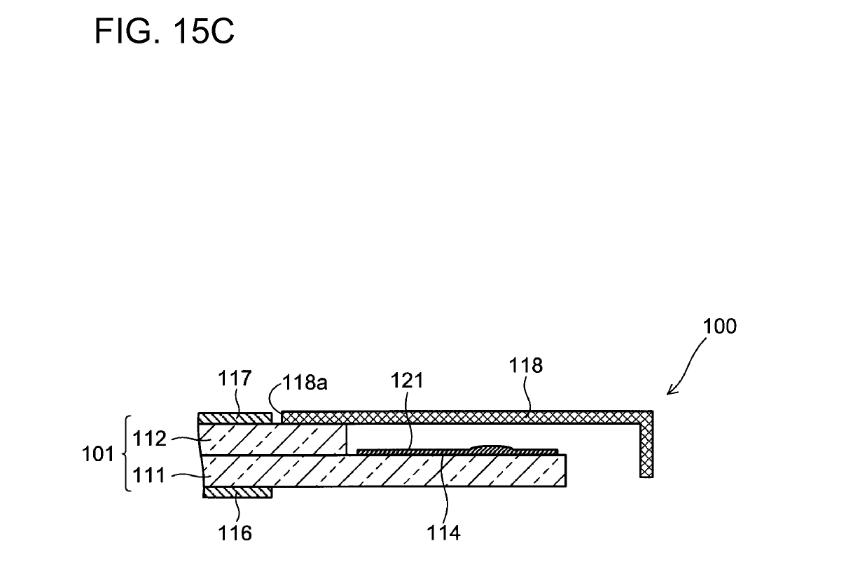

FIG. 14 is a plan view that shows another configuration of the insulating member 11 according to the present embodiment. As shown in the same figure, cutouts 11e that are cutout portions of the insulating member 11 may be formed in the insulating member 11 at positions that correspond to four points of the perimeter of the driver circuit chip 5. The cutouts 11e are formed by cutting out a portion of the insulating member 11 at the four points at which the short sides 5a and the long sides 5b of the driver circuit chip 5 intersect.

In this configuration, it is possible to create a step that corresponds to the thickness of the driver circuit chip 5 at the four points in the insulating member 11 and it is possible to properly protect the driver circuit chip 5 and the wiring 6 in this case as well.

In the above, a display device was described as being the liquid crystal display device 1 as an example, but it is possible to apply the configurations of the above-mentioned embodiments to other display devices, such as organic electroluminescence (EL) display devices. Because of this, it is possible to achieve similar effects to those mentioned above. In other words, even in organic EL display devices or the like, wiring can be protected and display abnormalities by a short circuit can be prevented at the same time by simultaneously covering the driver circuit chip and the wiring that are directly formed on the substrate of the display unit with a single insulating member.

It is also possible to form the liquid crystal display device 1 by appropriately combining the configurations of the insulating member 11 as explained in each embodiment. For example, it is possible to replace the four cutouts 11d shown in FIG. 14 with four slits, or form a combination of slits and cutouts.

A display device explained in each embodiment can be represented as follows.

The above-mentioned display device includes: a driver circuit chip that outputs a driving signal for controlling display of a display unit; and wiring that supplies the driving signal to the display unit, wherein the driver circuit chip and the wiring are directly formed on a substrate of the display unit and, on the substrate, are simultaneously covered by a single insulating member.

According to the above-mentioned configuration, the wiring and the driver circuit chip that are directly formed on the substrate of the display unit (using the COG method) are simultaneously covered by a single insulating member. Because of this, when holding the substrate in a shield case, for example, even when a section of the inner surface of the shield case is positioned on the upper part of the driver circuit chip, a short circuit between the driver circuit chip and the inner surface of the shield case can be prevented and, at the same time, corrosion and scratching of the wiring can also be prevented. Additionally, in order to prevent a short circuit, it is not necessary to secure clearance between the driver circuit chip and the inner surface of the shield case, which avoids increasing the thickness of the module. Furthermore, in comparison to a configuration in which the driver circuit chip and the wiring are covered by separate insulating members, manufacturing costs can be reduced since the driver circuit chip and the wiring are simultaneously covered by a single insulating member.

In other words, even when a driver circuit chip is mounted on a substrate using the COG method, it is possible to simultaneously protect wiring and prevent display abnormalities due to a short circuit without increasing the thickness or cost of the module.

Linearly cut slits may be formed in the insulating member at positions corresponding to an outline of the driver circuit chip.

Due to these slits being formed in the insulating member, an abrupt step can be created to correspond to the thickness of the driver circuit chip at the position of the outline of the driver circuit chip. Due to this, the driver circuit chip and the wiring can be properly protected by increasing the contact area between the insulating member and both the driver circuit chip and the wiring as much as possible.

The aforementioned driver circuit chip may have a rectangular shape in a plan view, and the linearly cut slits may be formed in the insulating member corresponding to each short side of the driver circuit chip, the linearly cut slits being formed at angles within a range of ±45° to the each short side.

If the slits that correspond to the short sides of the driver circuit chip are formed within the range of the above-mentioned angles, a step that corresponds to the thickness of the driver circuit chip can be created in the insulating member at the position of each short side of the driver circuit chip.

One end of each of the linearly cut slits may extend to the same side of the outline of the insulating member. In this case, the insulating member (an insulating tape, for example) between the slits can be bent to a position that is almost flat and attached so as to cover the driver circuit chip, making the insulating member easier to attach.

The driver circuit chip may have a rectangular shape in a plan view, and the linearly cut slits may be formed in the insulating member and correspond to each long side of the driver circuit chip, the linearly cut slits being formed at angles within a range of ±45° to the each long side.

If each slit that corresponds to each long side of the driver circuit chip is formed within the range of the above-mentioned angles, a step that corresponds to the thickness of the driver circuit chip can be created in the insulating member at the position of each long side of the driver circuit chip.

The insulating member may have cutouts that are cutout portions formed at positions corresponding to an outline of the driver circuit chip.

Due to these cutouts being formed in the insulating member, an abrupt step that corresponds to the thickness of the driver circuit chip can be created in the insulating member at the position of the outline of the driver circuit chip. Because of this, the driver circuit chip and the wiring can be properly protected by increasing the contact area between the insulating member and both the driver circuit chip and the wiring as much as possible.

The driver circuit chip may have a rectangular shape in a plan view, and the cutouts may be formed corresponding to each short side of the driver circuit chip by cutting out respective portions of the insulating member at angles within a range of ±45° with respect to the each short side.

If the cutouts that correspond to the short sides of the driver circuit chip are formed within a range of the above-mentioned angles, a step that corresponds to the thickness of the driver circuit chip can be created in the insulating member at a position of each short side of the driver circuit chip.

One end of each of the cutouts may have an opening at a position on the same side of the outline of the insulating member. In this case, it is possible to bend a section of the insulating member (an insulating tape, for example) so as to be almost flat and attach the insulating member so as to cover the driver circuit chip, making the insulating member easier to attach.

The driver circuit chip may have a rectangular shape in a plan view, and the cutouts may be formed corresponding to each long side of the driver circuit chip by cutting out a portion of the insulating member at angles within a range of ±45° with respect to the each long side.

If each cutout that corresponds to each long side of the driver circuit is formed within the range of the above-mentioned angles, a step that corresponds to the thickness of the driver circuit chip can be created in the insulating member at the position of each long side of the driver circuit chip.

The driver circuit chip may have a rectangular shape in a plan view, and the cutouts may be formed corresponding to four points around the driver circuit chip by cutting out a portion of the insulating member in a direction that intersects with a short side and a long side of the driver circuit chip.

In the case of cutouts being formed in the insulating member at positions that correspond to four points around the driver circuit chip, a step that corresponds to the thickness of the driver circuit chip at those four points can be created.

The display unit may be a liquid crystal display unit having a liquid crystal layer sandwiched between a pair of substrates, displaying images, and the substrate on which the driver circuit chip and the wiring are formed is one substrate of the pair of substrates.

In this case, the abovementioned effects can be achieved in a liquid crystal display device.

The liquid crystal display unit may have a plurality of pixels, and the one substrate of the pair of substrates may be a glass substrate on which switching elements are formed for turning ON and OFF display of each pixel of the liquid crystal display unit in accordance with the driving signal. In this manner, the abovementioned effects can be achieved in a configuration in which the so-called COG method is used to form a driver circuit chip on the glass substrate on which switching elements are formed.

The display device according to the above-mentioned configuration may further include a shield case for holding the substrate on which the driver circuit chip and the wiring are formed, and one section of an inner surface of the shield case may face, across the insulating member, the driver circuit chip that is formed on the substrate.

Here, the insulating member can prevent the generation of a short circuit between the driver circuit chip and the inner surface of the shield case, and the generation of display abnormalities due to a short circuit can be prevented without providing clearance between the driver circuit chip and the inner surface of the shield case, which avoids increasing the thickness of the module.

### INDUSTRIAL APPLICABILITY

The present invention can be used in a display device having a driver circuit chip mounted on a substrate using the COG method.

### DESCRIPTION OF REFERENCE CHARACTERS

1 liquid crystal display device (display device)

2a liquid crystal display unit (display unit)

3 substrate

4 substrate

5 driver circuit chip

5a short side

5b long side

6 wiring

10 shield case

11 insulating member

11a slit

11b slit

11c cutout

11d cutout

11e cutout

1. A display device, comprising:
a driver circuit chip that outputs a driving signal for controlling display of a display unit; and
wiring that supplies said driving signal to said display unit,
wherein said driver circuit chip and said wiring are directly formed on a substrate of the display unit and, on said substrate, are simultaneously covered by a single insulating member.

2. The display device according to claim 1, wherein linearly cut slits are formed in the insulating member at positions corresponding to an outline of the driver circuit chip.

3. The display device according to claim 2,
wherein the driver circuit chip has a rectangular shape in a plan view, and
wherein the linearly cut slits are formed in the insulating member corresponding to each short side of the driver circuit chip, said linearly cut slits being formed at angles within a range of ±45° to said each short side.

4. The display device according to claim 3, wherein one end of each of the linearly cut slits extends to the same side of the outline of the insulating member.

5. The display device according to claim 2,
wherein the driver circuit chip has a rectangular shape in a plan view, and
wherein said linearly cut slits are formed in said insulating member and correspond to each long side of said driver circuit chip, said linearly cut slits being formed at angles within a range of ±45° to said each long side.

6. The display device according to claim 1, wherein the insulating member has cutouts formed at positions corresponding to an outline of the driver circuit chip.

7. The display device according to claim 6,
wherein the driver circuit chip has a rectangular shape in a plan view, and
wherein the cutouts are formed corresponding to each short side of said driver circuit chip such that long edges of the cutouts are within a range of ±45° with respect to said each short side.

8. The display device according to claim 7, wherein one end of each of the cutouts has an opening at a position on the same side of the outline of said insulating member.

9. The display device according to claim 6,
wherein said driver circuit chip has a rectangular shape in a plan view, and
wherein said cutouts are formed corresponding to each long side of said driver circuit chip such that long edges of the cutouts are within a range of ±45° with respect to said each long side.

10. The display device according to claim 6,
wherein said driver circuit chip has a rectangular shape in a plan view, and
wherein said cutouts are formed corresponding to four corners of said driver circuit chip such that long edges of the cutouts are angled with respect to a short side and a long side of said driver circuit chip.

11. The display device according to claim 1,
wherein said display unit is a liquid crystal display unit having a liquid crystal layer sandwiched between a pair of substrates, displaying images, and
wherein said substrate on which said driver circuit chip and said wiring are formed is one substrate of the pair of substrates.

12. The display device according to claim 11,
wherein said liquid crystal display unit has a plurality of pixels, and
wherein said one substrate of the pair of substrates is a glass substrate on which switching elements are formed for turning ON and OFF display of each pixel of the liquid crystal display unit in accordance with the driving signal.

13. The display device according to claim 1, further comprising:
a shield case for holding said substrate on which the driver circuit chip and the wiring are formed,
wherein one section of an inner surface of said shield case faces, across the insulating member, the driver circuit chip that is formed on the substrate.
